(19) United States
(12) Patent Application Publication
(10) Pub. No.: US 2016/0330938 A1
(43) Pub. Date: Nov. 17, 2016

(54) HYGIENIC HONEY BEE BOTTOM BOARD

(71) Applicant: Edgar Reeves Jones, Jackson, MS (US)

(72) Inventor: Edgar Reeves Jones, Jackson, MS (US)

(21) Appl. No.: 15/155,611

(22) Filed: May 16, 2016

Related U.S. Application Data
(60) Provisional application No. 62/161,827, filed on May 14, 2015.

(51) Int. Cl. A01K 47/06; A01M 1/10; A01K 55/00; A01K 47/02; A01K 51/00

(52) U.S. Cl. CPC A01K 47/06; A01K 47/02; A01K 51/00; A01K 55/00; A01M 1/103

(57) ABSTRACT

A hygienic honey bee bottom board, hives employing the same, and methods related to the same are provided. The hygienic honey bee bottom board effectively diminishes small hive beetles in a bee hive without significant pollen loss. The invention has a solid bottom board platform with screened receptacles. Hygienically inclined bees instinctively chase small hive beetles into the screened receptacles in an effort to clean the hive. The small hive beetles fall through the screened receptacles into a beetle trap disposed below the bottom board receptacles and are thus removed from the hive with minimal disturbance of the hive. The screened receptacles of the hygienic honey bee bottom board comprise only a limited area of the otherwise solid bottom board platform. This allows worker bees to retrieve substantial amounts of pollen dropped onto the solid bottom board platform for use as foodstuff.

### CROSS-REFERENCE TO RELATED APPLICATIONS

This application claims priority to U.S. Provisional Application No. 62/161,827 to Edgar Reeves Jones filed on May 14, 2015, the contents of which are incorporated herein by reference in its entirety.

### FIELD OF THE INVENTION

The presently disclosed subject matter relates to honey bee hives and more particularly to hygienic bottom boards, hives with a hygienic bottom board, and methods relating to the same.

### BACKGROUND OF THE INVENTION

The United Nations estimates the global value of crops dependent on honey bee pollination was close to $200 billion in 2005. Honey bee colony losses due to small hive beetles (“SHB”), viral diseases carried by Varroa and other mites, colony collapse disorder (“CCD”), and/or a combination of these factors became a significant problem by the mid-2000s. In some regions of the United States and in Europe, honey bee colony losses exceeded 50% per winter season. While the exact cause of the population losses remains highly debated, the significant losses have had concrete effects on agriculture, including increased costs for commercial pollination of bee-dependent crops with these costs passed on to consumers.

Since the arrival of SHB in the United States, these insects have devastated honey bee populations in both commercial and hobbyist settings. Various devices were introduced to protect hives from SHB infestation. Some of these devices included internal “beetle traps” designed for placement inside a hive above the hive's solid bottom board platform. These internal beetle traps were inconvenient because they required a beekeeper to dismantle a hive to empty the traps, thus creating extra work for the beekeeper and considerable disruption to bees in the hive.

Full-length screened bottom boards were designed to control invasive SHB in bee hives as an alternative to the internal beetle traps situated above solid bottom board platforms. Unlike a solid bottom board platform, a full-length screened bottom board has a mesh screen that spans the length and width of a bottom board frame, save for the entrance and landing area for the hive. A full-length mesh screen allows beetles and mites that have entered a hive to fall through the screen onto the ground or into a beetle trap situated below the full-screened bottom board. Honey bees, however, are large enough to walk on top of the mesh screen without falling through.

The availability of pollen as a food source for developing brood and worker bees is an important aspect of bee culture. Pollen collected by worker bees is the primary food source for worker bees and the developing brood. Studies have shown that a favorable increase in brood production is directly proportional to the amount of pollen available to developing brood. (Oliver, R., “Understanding Colony Buildup and Decline,” American Bee Journal, April 2016, pp. 420-423, citing C. van Dooremalen, et al., J Insect Physiol., 2013, 59: 487-493; incorporated herein by reference to the extent not contradictory to the teachings herein). Additionally, both general health and productivity of developing brood and worker bees are also directly proportional to the amount of pollen available as a food source in the hive. (Oliver, R., “Understanding Colony Buildup and Decline,” American Bee Journal, April 2016, pp. 420-423, citing Scofield H N, Mattila H R, 2015, PLoS ONE 10(4): e0121731; incorporated herein by reference to the extent not contradictory to the teachings herein).

During pollen retrieval and storage activities in the hive, worker bees often drop balls of pollen as they enter and move about the hive's interior spaces. Worker bees can retrieve and use dropped pollen that falls onto a solid bottom board platform. Worker bees cannot retrieve and use dropped pollen that falls through a screen of the full-length screened bottom board because a screen large enough for SHBs to fall through is also large enough for pollen balls to fall through. A disadvantage of a full-length screened bottom board then is loss of 100% of dropped pollen balls that fall through its screen, and the full-length nature of the screen exacerbates the loss of fallen pollen.

It has been suggested that in a honey bee colony health and strength are the best defenses against the major problems facing honey bees today. Loss of a significant amount of pollen as a foodstuff due to use of a full-length screened bottom board could potentially harm the vitality of a honey bee colony and leave it vulnerable to SHB, parasites, disease, and CCD. These problems threaten the production of numerous bee-dependent pollinated fruit and vegetable crops in the United States and worldwide.

There exists a need for effective control of SHB that overcomes the deficiencies of the prior art of being labor intensive, cumbersome, disruptive to active hives while also preserving pollen and/or limiting its loss through fallen pollen in screened bottom board hives.

### SUMMARY OF THE INVENTION

According to the present invention there is provided an improved bottom board design that allows bees to actively participate in hive hygiene by intrinsically controlling SHB and simultaneously preserving pollen and/or limiting its loss through fallen pollen in screened bottom boards. It has now been surprisingly found that the combination of a solid bottom board platform with screened receptacles disposed in a limited area of a bottom board (the “hygienic honey bee bottom board”) effectively diminishes SHBs in a bee hive without a significant loss of pollen. By controlling SHB and increasing pollen availability as a foodstuff, a honey bee hive could be healthier, stronger, and more capable of withstanding other problems, such as disease, parasites, and climate issues.

### BRIEF DESCRIPTION OF THE DRAWINGS

Further advantages of the invention will become apparent by reference to the detailed description of preferred embodiments when considered in conjunction with the drawings which form a portion of the disclosure and wherein:

FIG. 1 is an exploded view of an exemplary embodiment of a hygienic honey bee bottom board.

FIG. 2 is a perspective view of the hygienic honey bee bottom board shown in FIG. 1.

FIG. 3 is a rear perspective view of the hygienic honey bee bottom board shown in FIG. 1 showing the closed hinged access door.

FIG. 4 is a rear bottom perspective of the hygienic honey bee bottom board shown in FIG. 1 showing the screened receptacles from within the hygienic honey bee bottom board and the opened hinged access door.

FIG. 5 is a perspective view of an exemplary embodiment of a hygienic honey bee bottom board with a shallow beetle trap pan.

FIG. 6 is a front top view of an exemplary embodiment of the hygienic honey bee bottom board shown in FIG. 5 with a commercially available beetle trap with screen and pan.

FIG. 7 is a rear perspective view of a Langstroth style hive being field tested with an exemplary embodiment of a hygienic honey bee bottom board with a shallow beetle trap pan.

FIG. 8 is an alternative view of the Langstroth style hive being field tested with a hygienic honey bee bottom board with a shallow beetle trap pan shown in FIG. 7.

FIG. 9 is a front perspective view of the Langstroth style hive being field tested with a hygienic honey bee bottom board with a shallow beetle trap pan shown in FIG. 7 showing the landing area of the hygienic honey bee bottom board.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. Further, while the terms used herein are believed to be well-understood by one of ordinary skill in the art, definitions are set forth to facilitate explanation of the presently-disclosed subject matter. The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed above.

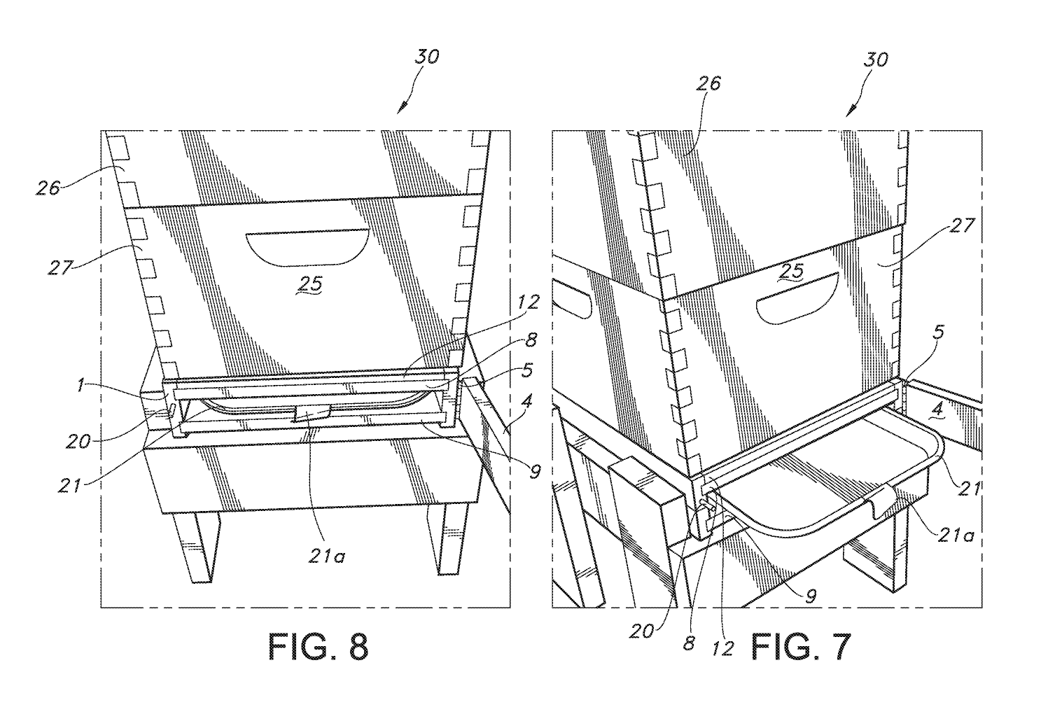

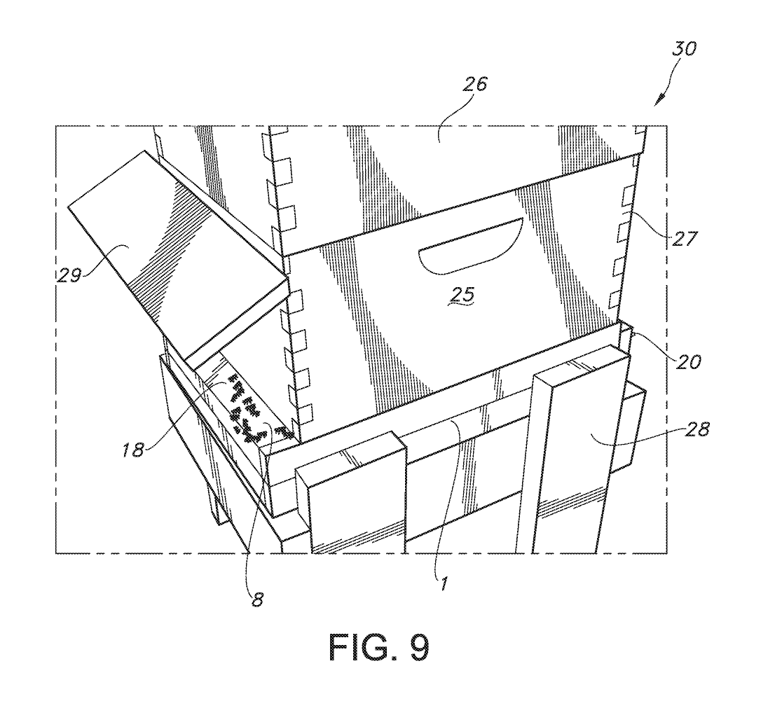

A traditional Langstroth honey bee hive 25 is comprised of a hive stand 28, a solid bottom board platform 8, a hive body for brood production 27 (more than one brood body 27 may be used), one or more supers 26 for honey storage and harvest (the number of supers 26 used will normally depend on the honey-making activity of the hive), and an exterior top (not shown). The hive brood body 27 and supers 26 are positioned on top of the solid bottom board platform, which also serves as a landing area and entrance 18 for the bees into the hive 25. The landing area and entrance 18 is created by the bottom board 8 platform being a longer dimension than the hive brood body 27 and supers 26. Reference can be made to FIGS. 7-9 for a traditional Langstroth honey bee hive 25 as modified with an embodiment of the present invention. I have surprisingly found that the combination of a solid bottom board platform 8 with screened 16 receptacles 6 disposed in a limited area of the bottom board (the “hygienic honey bee bottom board” 1) effectively diminishes SHBs in a bee hive 30 without a significant loss of pollen, which is a disadvantage in full-length screened bottom boards. Unlike full-length screened bottom boards which lose 100% of pollen balls dropped by worker bees, the hygienic honey bee bottom board's 1 screened 16 receptacles 6 compromise only a limited area of its otherwise solid bottom board platform 8, thus allowing worker bees to retrieve substantial amounts of dropped pollen balls from the solid area of the bottom board platform of the apparatus for use as foodstuff Increasing the availability of pollen as a food source for developing brood and worker bees is a substantial advantage of the hygienic honey bee bottom board 1 over a full-length screened bottom board.

While only a Langstroth style honey bee hive 25 is shown and discussed herein, it will be appreciated by a person of ordinary skill in the art that the hygienic honey bee bottom board 1 can be modified for use in other styles of hives, including but not limited to Warré hives, top-bar hives, and others. These modified hygienic honey bee bottom board 1 and hives are fully contemplated to be within the scope of the present invention.

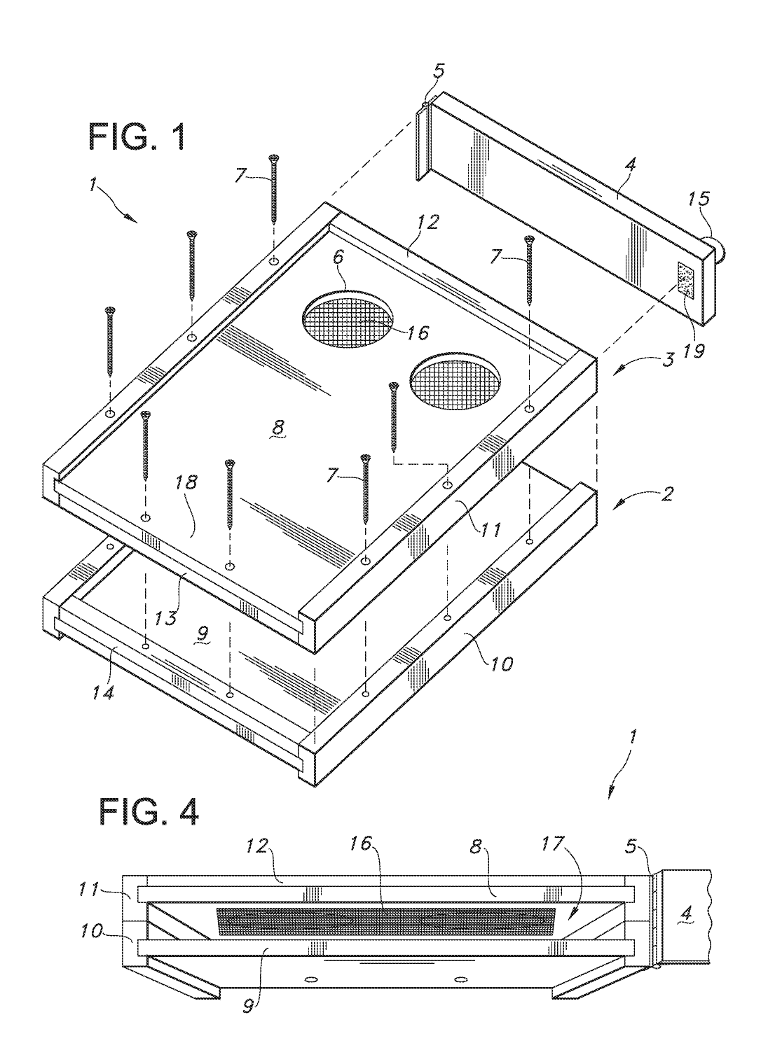

Referring now to FIG. 1, the hygienic honey bee bottom board 1 is a two component (2 & 3) hive bottom board configuration comprising an upper component 3 and a lower component 2 which are attached with fasteners 7, e.g., screws (shown in FIGS. 1-3), bolts, nails, adhesive, or other known fasteners.

The upper component 3 has side rails 11 which hold a bottom board platform 8. As shown in FIGS. 1 & 7, the upper side rails 11 and the upper rear cleat 12 of the upper component 3 support a Langstroth style bee hive 30 placed above the bottom board platform 8 of the hygienic honey bee bottom board 1.

The bottom board platform 8 has one or more screened 16 receptacles 6. The one or more screened 16 receptacles 6 may be any size, so long as the size only consumes a limited area of the bottom board platform 8. The limited area of the bottom board platform 8 may be less than 50%. Preferably, the screened 16 receptacles 6 are about 5% to about 25% and more preferably about 10% to about 20% of the total area of the bottom board platform 8. The one or more screened 16 receptacles 6 may also take on any shape that is practical for manufacture. The preferred configuration is a pair of circular-shaped screened 16 receptacles 6, which helps structural integrity of the bottom board platform 8 by limiting sagging, warping, etc. The one or more screened 16 receptacles 6 may be located anywhere on the bottom board platform 8. I have found that more pollen drop occurs at or near the entrance area of hives. Thus, the screened 16 receptacles 6 are preferably located on the bottom board platform 8 at the end opposite of a landing entrance area 18. This placement of the screened 16 receptacles 6 also creates a convenient and less disruptive placement of an access door 4 for periodic monitoring and cleaning of a beetle trap (e.g., a beetle trap pan 21) below the screened 16 receptacles 6 (discussed further below).

The upper component 3 also has an upper front cleat 13 located below the bottom board platform 8 at the landing and entrance 18 side of the bottom board platform 8. In conjunction with a lower front cleat 14 located directly below the upper front cleat 13 on the lower component 2, the upper front cleat 13 seals an interior compartment 17 below the bottom board platform 8 when the upper component 3 is attached to the lower component 2 during assembly. The lower component 2 is constructed with side rails 10 that hold a floor board 9. The lower component 2 has a lower front cleat 14 (discussed above).

Any sturdy material or mixture of such can be used to construct the upper component 3 and lower component 2. While wood is preferred and rot-resistant wood (e.g., cypress wood) is particularly preferred, plywood, particle board, composite materials, and plastics may also be used. Any screening material that is of a size that allows SHBs (approximately 0.5 cm) to fall through but not honey bees can be used for the screened mesh 16 of the receptacles 6. This size also allows for bee mites that are smaller than SHBs to fall through.

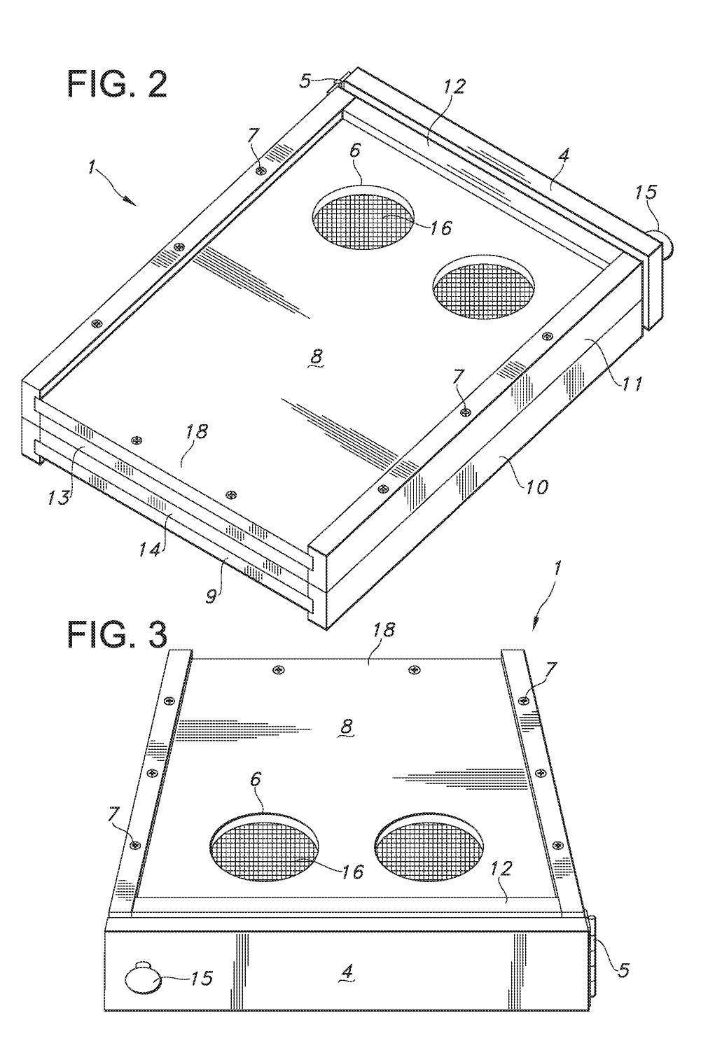

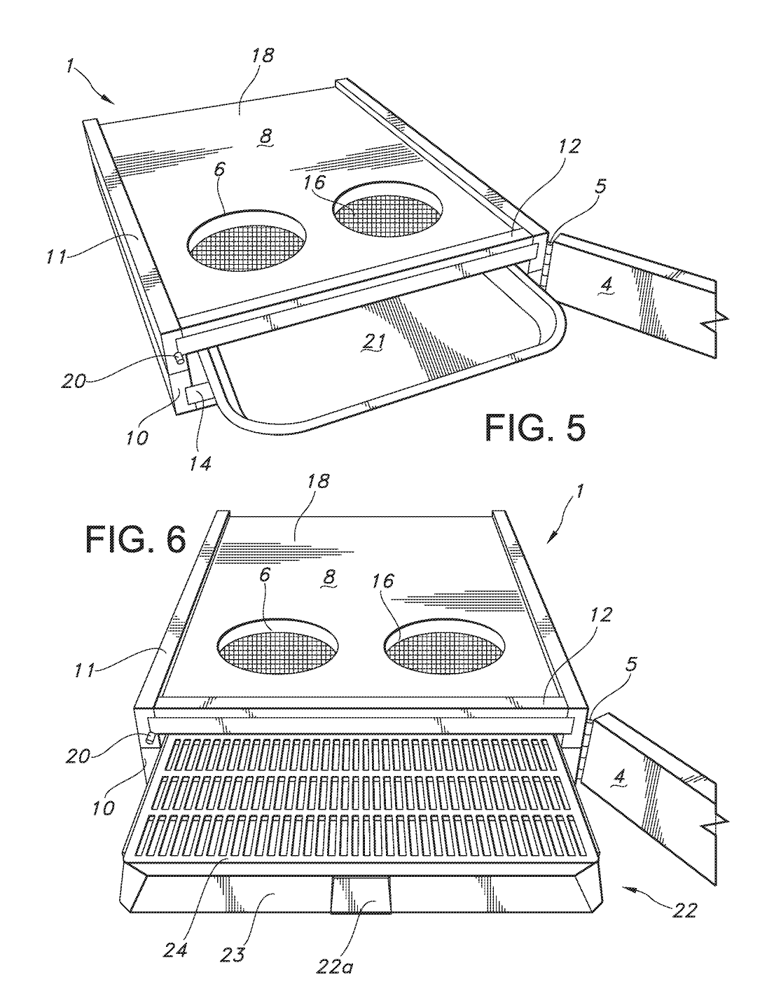

As can be appreciated from FIGS. 4-8, the hygienic honey bee bottom board 1 also has a hinged 5 access door 4, which acts to close and seal the interior compartment 17 when the hygienic honey bee bottom board 1 is fully assembled. The hinge 5, may be placed on any side of the access door 4. In addition to or in lieu of hinge 5, the access door 4 may be held in place by paired magnet/metal latches 19, threaded rods with matching nut 20, or other known mechanism/construction technique. Securely closing the access door 4 prevents an alternative path for pests to enter the hive. The hinged 5 access door 4 may optionally have a rear door knob 15 to conveniently allow for opening and closing the interior compartment 17 beneath the bottom board platform 8. As shown in FIGS. 2-3 & 9, the access door 4 is ordinarily kept securely closed (note that the apparent gap shown in FIGS. 2-3 is exaggerated for illustration purposes only). As mentioned above, paired magnet/metal latches 19 (see FIG. 1) and/or threaded rods with matching nut 20 (see FIGS. 7-9) can be used to hold the access door 4 securely closed.

The interior compartment 17 is preferably designed to be constructed with dimensions to accommodate a commercial beetle trap tray 22 (as shown in FIG. 6) or a smaller, less expensive plastic tray 21 available to both commercial and hobbyist beekeepers. Any shallow pan or tray that can be placed within the interior compartment 17 can be used as a beetle trap with the hygienic honey bee bottom board 1. By opening the access door 4, the beekeeper can pull out the beetle traps (21/22), optionally by handles 21a/22a. Commercial beetle traps 22 are widely available, but the large size of these traps 22 is meant to extend beneath an entire full-length screened bottom board. Because the hygienic honey bee bottom board 1 only has a limited area used as screened 16 receptacles 6, smaller trays (not shown) that fit under the receptacles 6 and that are just wider than the dimensions of the receptacles 6 necessarily require less trapping oil or other trap liquids or adhesives and are less cumbersome to monitor and clean. Thus, this is another cost and time saving advantage of the hygienic honey bee bottom board 1. The access door 4 provides convenient access to the interior compartment 17 for easy removal and cleaning of a beetle trap tray (e.g., 21/23).

Honey bees enter a hive 30 at the landing area entrance 18 of the hygienic honey bee bottom board 1. Once inside the hive 30, honey bees crawl across the bottom board platform 8 until they ascend into the upper hive 26 & 27. Small hive beetles also enter a bee hive at the landing area entrance 18. Once inside the hive 30, SHBs also crawl across the bottom board platform 8 searching for access to the upper hive 26 & 27.

Due to their hygienic tendencies, honey bees will chase SHBs that enter a hive 30. When chased by a bee across the bottom board platform 8, a SHB will crawl into a screened 16 receptacle 6 in an attempt to escape the pursuing honey bee. The SHB falls through the screened 16 receptacle 6 into the interior compartment 17 below the bottom board platform 8 where a beetle tray (e.g., 21) can capture the SHB. The size of the mesh screen 16 also allows for mites to fall through without being able to return into the hive 30.

A full-length screened bottom board allows all objects the size of a SHB to fall through the entire length and width of the bottom board's mesh screened area. These objects include hive debris and dropped pollen balls in addition to SHBs. This aspect of a full-length screened bottom board is a disadvantage because significant amounts of dropped pollen fall through the full-length screened bottom board and are irretrievably lost, thus depriving the honey bees of an important food source.

Unlike a full-length screened bottom board, the hygienic honey bee bottom board 1 permits only objects that enter the limited area of the receptacles 6 to fall through the mesh screen 16, thus making available to the honey bees all dropped pollen that falls onto the larger areas of the bottom board platform 8 where the screened 16 receptacles 6 are not located. By disposing the screened 16 receptacles 6 to the rear portion of the bottom board platform 8, even more fallen pollen can be retrieved by honey bees because most pollen tends to be dropped in the front portion of the hive 30.

In the above described manner, the hygienic honey bee bottom board 1 utilizes the hygienic tendencies of honey bees in conjunction with screened 16 receptacles 6 placed in the invention's bottom board platform 8 to effectively diminish SHBs in a bee hive 30 without a substantial loss of pollen for the bees.

In another aspect, the present invention provides a honey bee hive 30 comprising a hygienic honey bee bottom board 1, at least one hive brood body 27, at least one super 26, and an exterior top (not shown). The honey bee hive 30 may further comprise an optional hive stand 28 and/or an optional bee hive entrance awning 29, which is not a standard element for a Langstroth bee hive. Furthermore, the honey bee hive 30 optionally may further comprise a beetle trap tray (e.g., 21).

In still another aspect, the present invention provides a method of manufacture for a hygienic honey bee bottom board 1 comprising: providing a lower component 2 comprising a floor board platform 9, lower side rails 10, and a lower front cleat 14; providing an upper component 3 comprising a bottom board platform 8 with at least one screened 16 receptacle 6, upper side rails 11, and an upper front cleat 13; providing an access door 4; and attaching said lower component 2, said upper component 3, and said access door 4. The floor board platform 9, lower side rails 10, and a lower front cleat 14 of said lower component 2 may be pre-attached to each other by adhesive, nails, screws, bolts, staples, or other known means of fastening 7. The at least one screened 16 receptacle 6 may be precut from the bottom board platform 8 and have screen mesh 16 attached prior to attachment to said lower component 2. The bottom board platform 8, upper side rails 11, and an upper front cleat 13 of said upper component 3 may be pre-attached to each other by adhesive, nails, screws, bolts, staples, or other known means of fastening 7. Said lower component 2 and said upper component 3 may be attached using adhesive, nails, screws, bolts, staples, or other known means of fastening 7. The screen mesh 16 may be attached to the bottom side of the bottom board platform 8 covering the at least one receptacle 6 by adhesive, staples, nails, or other known means of fastening 7. Said access door 4 may be hinged 5. Said access door 4 may include an optional rear door knob 15. Said access door 4 may be attached to said lower component 2 and/or said upper component 3 by adhesive, nails, screws, bolts, staples, or other known means of fastening 7 or by paired magnetic latches 19 in a manner that allows said access door 4 to open and expose an interior space 17.

In yet another aspect, the present invention provides a kit for a honey bee hive 30 comprising a hygienic honey bee bottom board 1, at least one hive brood body 27, at least one super 26, and an exterior top. The kit for a honey bee hive 30 optionally further comprises a hive stand 28 and/or optionally a bee hive entrance awning 29. Also, the honey bee hive 30 optionally may further comprise a beetle trap tray (e.g., 21).

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

I claim:

1. A hygienic honey bee bottom board comprising a bottom board platform and at least one screened receptacle disposed on said bottom board platform.

2. The hygienic honey bee bottom board of claim 1, wherein said at least one screened receptacle occupies a limited area of said bottom board platform.

3. The hygienic honey bee bottom board of claim 1 further comprising a beetle trap for placement below said at least one screened receptacle.

4. The hygienic honey bee bottom board of claim 1, wherein said bottom board platform has a bee landing and entrance area.

5. The hygienic honey bee bottom board of claim 4, wherein said at least one screened receptacle is disposed on said bottom board platform in an area opposite said bee landing and entrance area.

6. The hygienic honey bee bottom board of claim 1 further comprising a lower component, an upper component, and an access door; wherein said upper component comprises said bottom board platform.

7. The hygienic honey bee bottom board of claim 6, wherein said lower component comprises a floor board platform, lower side rails, and a lower front cleat.

8. The hygienic honey bee bottom board of claim 6, wherein said upper component further comprises upper side rails and an upper front cleat.

9. The hygienic honey bee bottom board of claim 6 further comprising an interior space between said upper component and said lower component.

10. The hygienic honey bee bottom board of claim 9 further comprising a beetle trap for placement below said at least one screened receptacle.

11. The hygienic honey bee bottom board of claim 1, wherein said at least one screened receptacle is two screened receptacles.

12. The hygienic honey bee bottom board of claim 11, wherein said two screened receptacles occupy a limited area of said bottom board platform.

13. The hygienic honey bee bottom board of claim 11 further comprising a beetle trap for placement below said two screened receptacles.

14. The hygienic honey bee bottom board of claim 11, wherein said bottom board platform has a bee landing and entrance area.

15. The hygienic honey bee bottom board of claim 14, wherein said two screened receptacles are disposed on said bottom board platform in an area opposite said bee landing and entrance area.

16. A method of manufacture for a hygienic honey bee bottom board comprising:
providing a lower component comprising a floor board platform, lower side rails, and a lower front cleat;
providing an upper component comprising a bottom board platform with at least one receptacle, upper side rails, and an upper front cleat;
providing an access door;
attaching a screen mesh to the bottom side of said bottom board platform to form at least one screened receptacle; and
attaching said lower component, said upper component, and said access door.

17. The method of claim 16 further comprising cutting said at least one receptacle prior to attaching said lower component, said upper component, and said access door.

18. The method of claim 16, wherein said access door is hinged.

19. The method of claim 16 further comprising securing said access door with a threaded rod and a matching nut.

20. A kit for a honey bee hive comprising a hygienic honey bee bottom board, at least one Langstroth style hive brood body, at least one Langstroth style super, a Langstroth style exterior top, and optionally further comprising a beetle trap tray.
